(19) United States
(12) Patent Application Publication
(10) Pub. No.: US 2025/0286085 A1
(43) Pub. Date: Sep. 11, 2025

(54) FUEL CELL COOLING SYSTEM

(71) Applicant: TOYOTA JIDOSHA KABUSHIKI KAISHA, Toyota-shi (JP)

(72) Inventor: Hiromichi SATO, Hadano-shi (JP)

(73) Assignee: TOYOTA JIDOSHA KABUSHIKI KAISHA, Toyota-shi (JP)

(21) Appl. No.: 18/976,372

(22) Filed: Dec. 11, 2024

(30) Foreign Application Priority Data
Mar. 5, 2024 (JP) 2024-032834

(51) Int. Cl. H01M 8/0267; H01M 8/04014; H01M 8/04746

(52) U.S. Cl. CPC H01M 8/0267; H01M 8/04014; H01M 8/04768

(57) ABSTRACT

In the fuel cell cooling system, a first cooling channel, a fuel cell, a second cooling channel, a radiator, a heater, a heater core, and an intermediate heat exchanger are provided, and the second cooling channel includes a bypass channel provided in parallel to the radiator, and during power generation of the fuel cell, the coolant is circulated in the first cooling channel on a path through the fuel cell and the intermediate heat exchanger, and the coolant is circulated in the second cooling channel on a path through the intermediate heat exchanger, the heater, the heater core, and the bypass channel, thereby performing a first operation of heating air by the heater core. In the first operation, the temperature of the coolant in the second cooling channel is unlikely to decrease.

### CROSS-REFERENCE TO RELATED APPLICATION

This application claims priority to Japanese Patent Application No. 2024-032834 filed on Mar. 5, 2024, incorporated herein by reference in its entirety.

### BACKGROUND

### 1. Technical Field

The technology disclosed in the present specification relates to a fuel cell cooling system.

### 2. Description of Related Art

A fuel cell system disclosed in Japanese Unexamined Patent Application Publication No. 2002-33108 (JP 2002-33108 A) has a first cooling channel and a second cooling channel for circulating a coolant. A fuel cell is provided on the first cooling channel. A radiator is provided on the second cooling channel. An intermediate heat exchanger is provided across the first cooling channel and the second cooling channel. The intermediate heat exchanger exchanges heat between the first cooling channel and the second cooling channel.

### SUMMARY

In some cases, the fuel cell system is provided with a heater that heats the coolant and a heater core that heats air using heat of the coolant. Heating operations can be performed by the heater core. In the present specification, technology for reducing power consumption of a heater for heating coolant in a fuel cell system capable of heating operations is proposed.

### First Aspect

A fuel cell cooling system disclosed in the present specification includes
a first cooling channel in which coolant circulates,
a fuel cell provided on the first cooling channel,
a second cooling channel in which coolant circulates,
a radiator provided on the second cooling channel,
a heater that heats coolant in the second cooling channel,
a heater core that heats air by heat exchange with coolant in the second cooling channel, and an intermediate heat exchanger that performs heat exchange between the first cooling channel and the second cooling channel, in which
the second cooling channel includes a bypass channel provided in parallel to the radiator, and
during power generation by the fuel cell, a first operation is executable in which coolant is circulated in the first cooling channel over a path through the fuel cell and the intermediate heat exchanger, and also coolant is circulated in the second cooling channel over a path through the intermediate heat exchanger, the heater, the heater core, and the bypass channel, and the air is heated by the heater core.

In the fuel cell cooling system described above, the first operation can be executed during power generation by the fuel cell. In the first operation, the coolant circulates in the second cooling channel over a path passing through the intermediate heat exchanger, the heater, the heater core, and the bypass channel. The coolant circulates along the path bypassing the radiator, and accordingly the temperature of the coolant in the second cooling channel does not readily decrease. Further, the heat generated in the fuel cell is transferred to the second cooling channel through the first cooling channel and the heat exchanger, and accordingly the coolant in the second cooling channel can be heated by the intermediate heat exchanger. Thus, the electric power for the heater to heat the coolant flowing through the second cooling channel is reduced. As a result, power consumption of the heater can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a fuel cell cooling system;

FIG. 2 is a flowchart of an operation selection process of the fuel cell cooling system;

FIG. 3 is an explanatory diagram of a path;

FIG. 4 is an explanatory diagram of a path;

FIG. 5 is an illustration of a path; and

FIG. 6 is an explanatory diagram of a path.

### DETAILED DESCRIPTION OF EMBODIMENTS

Following the above aspect 1, additional configurations of the fuel cell cooling system disclosed herein are described below.

### Embodiment 2

The fuel cell cooling system according to aspect 1,
The second cooling channel,
A first circulation system including the bypass channel,
The second circulation system,
A first connecting channel connecting the first circulation system and the second circulation system,
A second connecting channel connecting the first circulation system and the second circulation system,
The intermediate heat exchanger and the radiator is provided in the first circulation system, the heater and the heater core are provided in the second circulation system, can perform the first operation and the second operation,
In the first operation, the intermediate heat exchanger, the first connecting channel, the heater, the heater core, the second connecting channel and circulating the coolant to the second cooling channel in a path passing through the bypass channel,
In the second operation, during power generation of the fuel cell, the coolant is circulated in the first cooling channel through the fuel cell and the intermediate heat exchanger, the coolant is circulated in the first circulation system in a path passing through the intermediate heat exchanger and the bypass channel, and the coolant is circulated in the second circulation system in a path passing through the heater and the heater core to heat the air by the heater core.

### Embodiment 3

The fuel cell cooling system according to aspect 1 or 2,
During power generation of the fuel cell, a third operation of circulating a coolant in the first cooling channel on a path through the fuel cell and the intermediate heat exchanger, circulating a coolant in the second cooling channel on a path through the intermediate heat exchanger, the heater, the heater core, and the radiator, and heating the air by the heater core may be performed.

### Embodiment 4

The fuel cell cooling system according to any one of aspects 1 to 3,
During power generation of the fuel cell, a fourth operation can be performed in which a coolant is circulated in the first cooling channel through the fuel cell and the intermediate heat exchanger, a coolant is circulated in the first circulation system in a path through the intermediate heat exchanger and the radiator, and a coolant is circulated in the second circulation system in a path through the heater and the heater core to heat air by the heater core.

### Embodiment 5

The fuel cell cooling system according to any one of aspects 1 to 4, wherein the first operation is performed when the temperature of the coolant in the first cooling channel is lower than the first reference value and the temperature of the coolant in the second cooling channel is higher than the second reference value.

### Embodiment 6

The fuel cell cooling system according to any one of aspects 1 to 5, wherein the second operation is performed when the temperature of the coolant in the first cooling channel is lower than the first reference value and the temperature of the coolant in the second cooling channel is lower than the second reference value.

### Embodiment 7

The fuel cell cooling system according to any one of aspects 1 to 6, wherein the third operation is performed when the temperature of the coolant in the first cooling channel is higher than the first reference value and the temperature of the coolant in the second cooling channel is higher than the second reference value.

### Embodiment 8

The fuel cell cooling system according to any one of aspects 1 to 7, wherein the fourth operation is performed when the temperature of the coolant in the first cooling channel is higher than the first reference value and the temperature of the coolant in the second cooling channel is lower than the second reference value.

According to the second aspect, the temperature of the fuel cell can be increased, and the heating operation can be performed independently in the second circulation system.

According to the third aspect, since the cooling of the coolant is performed by the radiator, the cooling of the fuel cell can be efficiently performed.

According to the fourth aspect, since the cooling of the coolant is performed by the radiator, the cooling of the fuel cell can be efficiently performed. Further, since the coolant circulates independently in the second circulation system, the coolant cooled by the radiator does not flow into the second circulation system, and the power consumption of the heater can be effectively reduced.

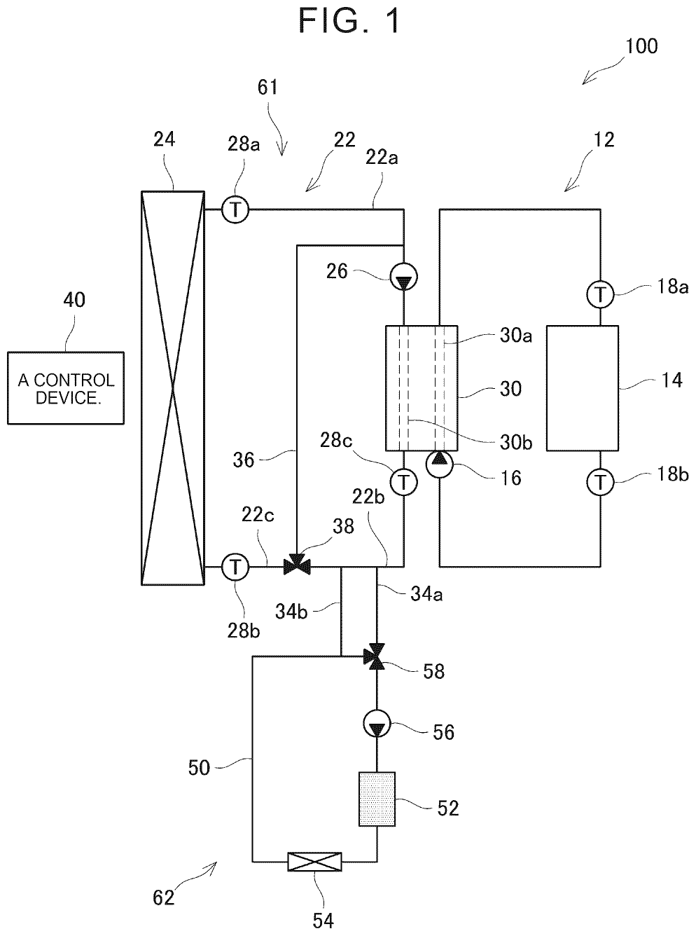

The fuel cell cooling system 100 shown in FIG. 1 is mounted on a device (for example, a fuel cell electric vehicle) using a fuel cell as a power source. The fuel cell cooling system 100 includes a first cooling channel 12, a second cooling channel 22, and an intermediate heat exchanger 30.

The intermediate heat exchanger 30 has a first heat exchange channel 30a and a second heat exchange channel 30b. The first heat exchange channel 30a is a part of the first cooling channel 12, and the second heat exchange channel 30b is a part of the second cooling channel 22. The intermediate heat exchanger 30 causes heat exchange between the first heat exchange channel 30a and the second heat exchange channel 30b. That is, the intermediate heat exchanger 30 causes heat exchange between the first cooling channel 12 and the second cooling channel 22.

A fuel cell 14 is provided in the first cooling channel 12. The fuel cell 14 is supplied with compressed air from an air compressor (not shown) and hydrogen from a tank (not shown). The fuel cell 14 generates electric power by reacting oxygen with hydrogen, and supplies electric power to a motor (not shown). The fuel cell 14 is cooled by the coolant in the first cooling channel 12.

The first cooling channel 12 is an annular channel. The first cooling channel 12 is provided with a pump 16 and a temperature sensor 18a, 18b. The pump 16 delivers the coolant from the installation position toward the intermediate heat exchanger 30. When the pump 16 is operated, the coolant circulates in the first cooling channel 12.

The temperature sensor 18a is provided in the first cooling channel 12 upstream of the fuel cell 14. The temperature sensor 18a detects the temperature of the coolant flowing into the fuel cell 14. The temperature sensor 18b is provided downstream of the fuel cell 14 in the first cooling channel 12. The temperature sensor 18b detects the temperature of the coolant discharged from the fuel cell 14 (hereinafter referred to as FC outlet temperature).

The second cooling channel 22 has a circulation system 61, a circulation system 62, a first connecting channel 34a, and a second connecting channel 34b. The first connecting channel 34a connects the circulation system 61 and the circulation system 62. The second connecting channel 34b connects the circulation system 61 and the circulation system 62.

The circulation system 61 includes a channel 22a, 22b, 22c, a bypass channel 36, a three-way valve 38, and a radiator 24. The channel 22a is connected to the upstream end of the second heat exchange channel 30b and the downstream end of the coolant channel in the radiator 24. The channel 22b is connected to the three-way valve 38 and the downstream end of the second heat exchange channel 30b. The channel 22c is connected to the three-way valve 38 and the upstream end of the coolant channel in the radiator 24. An upstream end of the bypass channel 36 is connected to the three-way valve 38. The downstream end of the bypass channel 36 is connected to the channel 22a. The three-way valve 38 switches between a state in which the channel 22b is connected to the channel 22c and a state in which the channel 22b is connected to the bypass channel 36. The radiator 24 cools the coolant flowing in the circulation system 61 by heat exchange with the outside air.

The circulation system 61 is provided with a pump 26 and a temperature-sensor 28a, 28b, 28c. The pump 26 is a channel 22a and is provided between the intermediate heat exchanger 30 and the bypass channel 36. The pump 26 delivers the coolant from the installation position toward the intermediate heat exchanger 30. When the pump 26 is operated, the coolant circulates in the second cooling channel 22.

The temperature sensor 28a is provided in the channel 22a. The temperature sensor 28a detects the temperature of the coolant emitted from the radiator 24. The temperature sensor 28b is provided in the channel 22c. The temperature sensor 28b detects the temperature of the coolant flowing into the radiator 24. The temperature sensor 28c is provided in the channel 22b. The temperature sensor 28c detects the temperature of the coolant emitted from the intermediate heat exchanger 30. That is, the temperature sensor 28c detects the outlet temperature of the intermediate heat exchanger 30.

The circulation system 62 has an air-conditioning channel 50. The air-conditioning channel 50 is an annular channel. The first connecting channel 34a connects the air-conditioning channel 50 and the channel 22b of the circulation system 61. The second connecting channel 34b connects the air-conditioning channel 50 and the channel 22b of the circulation system 61. The connecting portion between the first connecting channel 34a and the channel 22b is located upstream of the connecting portion between the second connecting channel 34b and the channel 22b in the channel 22b. The air-conditioning channel 50 is provided with a heater 52, a heater core 54, a pump 56, and a three-way valve 58.

The three-way valve 58 is provided at a connection portion between the first connecting channel 34a and the air-conditioning channel 50. In other words, the three-way valve 58 is connected to the first connecting channel 34a, the upstream portion of the air-conditioning channel 50, and the downstream portion of the air-conditioning channel 50. The three-way valve 58 switches between a first state in which the coolant flows from the first connecting channel 34a to the air-conditioning channel 50 and a second state in which the coolant does not flow from the first connecting channel 34a to the air-conditioning channel 50. In the first condition, the coolant flows from the first connecting channel 34a to the downstream portion of the air-conditioning channel 50 via the three-way valve 58. In the second state, the coolant flows from the upstream portion of the air-conditioning channel 50 to the downstream portion of the air-conditioning channel 50 via the three-way valve 58.

The pump 56 is provided in the air-conditioning channel 50 on the downstream side of the three-way valve 58. The pump 56 delivers the coolant from the installation position toward the heater 52.

The heater 52 is provided in the air-conditioning channel 50 on the downstream side of the pump 56. The heater 52 heats the coolant flowing through the air-conditioning channel 50.

The heater core 54 is provided in the air-conditioning channel 50 on the downstream side of the heater 52. The heater core 54 performs heat exchange between the coolant in the air-conditioning channel 50 and the outside air, and heats the air. The air heated by the heater core 54 is supplied to the vehicle interior, thereby adjusting the vehicle interior temperature.

When the fuel cell 14 generates electricity, the fuel cell 14 generates heat. The control device 40 activates the pumps 16, 26 during power generation of the fuel cell 14. When the pump 16 is operated, the coolant circulates in the first cooling channel 12. When the pump 26 is operated, the coolant circulates in the second cooling channel 22. The fuel cell 14 is cooled by heat exchange between the coolant in the first cooling channel 12 and the fuel cell 14. The heat generated by the power generation of the fuel cell 14 is transferred to the intermediate heat exchanger 30 (that is, the first heat exchange channel 30a) by the coolant in the first cooling channel 12. The intermediate heat exchanger 30 transfers heat from the first heat exchange channel 30a to the second heat exchange channel 30b.

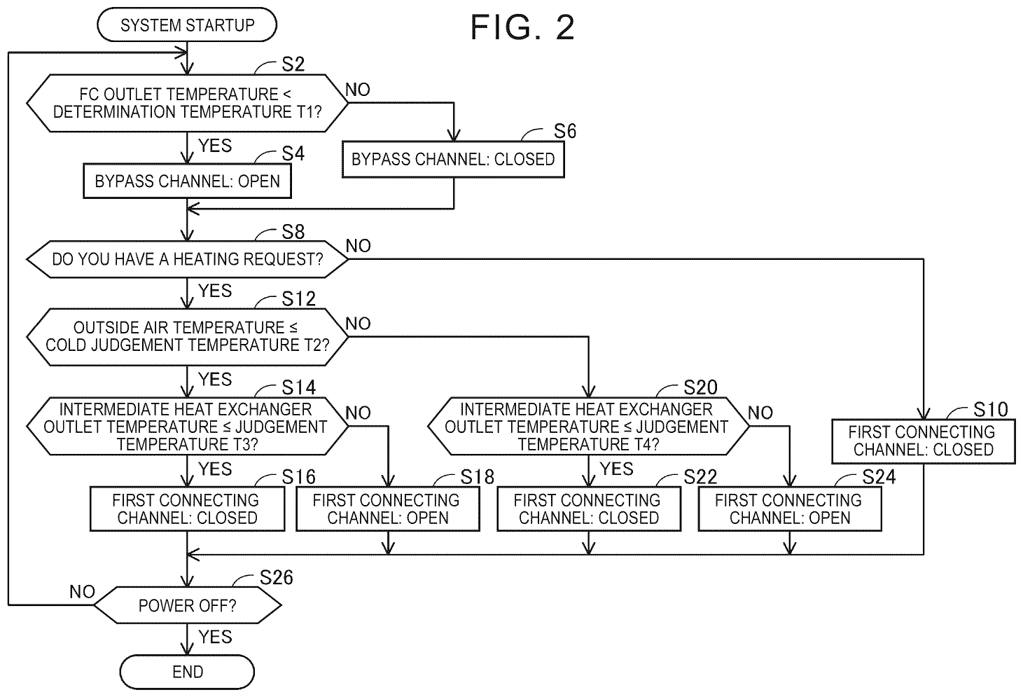

The fuel cell cooling system 100 executes the flowchart shown in FIG. 2 during power generation of the fuel cell 14.

In S2, the control device 40 determines whether FC outlet temperature is less than the determination temperature T1. If FC outlet temperature is less than the determination temperature T1 (if S2 is YES), the control device 40 controls the three-way valve 38 with the bypass channel 36 open (S4). In this case, no coolant flows through the radiator 24. In addition, when FC outlet temperature is equal to or higher than the determination temperature T1 (NO in S2), the control device 40 controls the three-way valve 38 with the bypass channel 36 closed (S6). In this case, no coolant flows through the bypass channel 36.

Next, in S8, the control device 40 determines whether there is a heating demand. If there is no heating requirement (NO in S8), the control device 40 controls the three-way valve 58 with the first connecting channel 34a closed (S10). In this case, the coolant does not flow through the first connecting channel 34a and the second connecting channel 34b. That is, the coolant does not flow between the circulation system 61 and the circulation system 62. Also, in S10, the control device 40 does not activate the pump 56 and heaters 52. Therefore, the heater core 54 does not perform heating.

When FC outlet temperature is low (i.e., when the bypass channel 36 is open), in S10, the coolant delivered by the pump 26 circulates in the second cooling channel 22 in a path passing through the intermediate heat exchanger 30, the channel 22b, and the bypass channel 36. Since the coolant in the second cooling channel 22 is not cooled by the radiator 24, the temperature of the coolant flowing into the intermediate heat exchanger 30 is not very low. Therefore, in the intermediate heat exchanger 30, the cooling efficiency when cooling the coolant in the first cooling channel 12 is low. Therefore, the cooling efficiency of the fuel cell 14 is low, and the temperature of the fuel cell 14 gradually increases. In this way, when FC outlet temperature is low (that is, when the temperature of the fuel cell 14 is low), the temperature of the fuel cell 14 is increased to increase the power generation efficiency of the fuel cell 14.

When FC outlet temperature is high (i.e., when the bypass channel 36 is closed), in S10, the coolant delivered by the pump 26 circulates in the second cooling channel 22 in a path passing through the intermediate heat exchanger 30, the channel 22b, the channel 22c, the radiator 24, and the channel 22a. Since the coolant in the second cooling channel 22 is cooled by the radiator 24, the temperature of the coolant flowing into the intermediate heat exchanger 30 is low. Therefore, in the intermediate heat exchanger 30, the coolant in the first cooling channel 12 is efficiently cooled. Therefore, the fuel cell 14 is efficiently cooled by the coolant in the first cooling channel 12. Thus, when FC outlet temperature is high (i.e., when the temperature of the fuel cell 14 is high), the radiator 24 is operated to efficiently cool the fuel cell 14.

The control device 40 repeatedly executes S10, S26 from S2 while there is no heating demand. Thus, while there is no heating demand, the control device 40 performs S10 operations described above until the power of the vehicles is OFF (i.e., YES at S26).

The control device 40 activates the pump 56 when there is a heating demand (S8 and YES). The coolant sent out from the pump 56 flows in the order of the heater 52 and the heater core 54.

After the pump 56 is activated, the control device 40 determines whether the outside air temperature is less than or equal to the cold determination temperature T2 in S12. When the outside air temperature is equal to or lower than the cold determination temperature T2 (YES in S12), the control device 40 next determines whether or not the outlet temperature of the intermediate heat exchanger 30 is equal to or lower than the determination temperature T3 (S14).

When the outlet temperature of the intermediate heat exchanger 30 is equal to or lower than the determination temperature T3 (YES in S14), the control device 40 controls the three-way valve 58 with the first connecting channel 34a closed (S16). In this case, the coolant does not flow through the first connecting channel 34a and the second connecting channel 34b. That is, the coolant does not flow between the circulation system 61 and the circulation system 62.

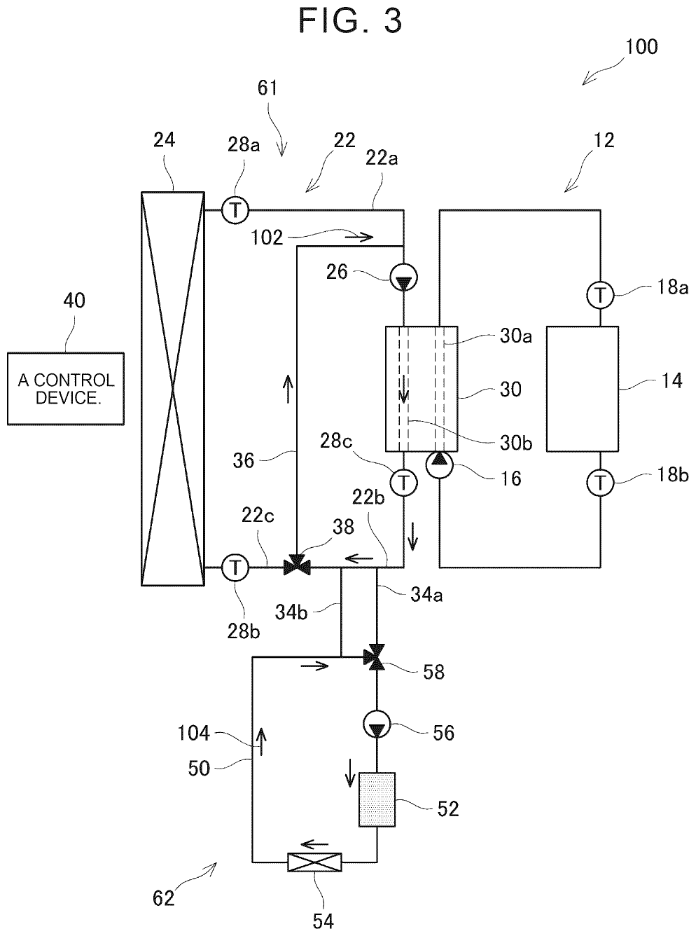

When FC outlet temperature is low (i.e., when the bypass channel 36 is open), in S16, the coolant in the second cooling channel 22 circulates in the paths 102 and 104 indicated by the arrows in FIG. 3. In the path 102, the coolant delivered by the pump 26 circulates in the circulation system 61 in a path passing through the intermediate heat exchanger 30, the channel 22b, and the bypass channel 36. Since the coolant in the circulation system 61 is not cooled by the radiator 24, the temperature of the coolant flowing into the intermediate heat exchanger 30 is not very low. Therefore, in the intermediate heat exchanger 30, the cooling efficiency when cooling the coolant in the first cooling channel 12 is low. Therefore, the cooling efficiency of the fuel cell 14 is low, and the temperature of the fuel cell 14 gradually increases. As described above, when FC outlet temperature is lower, the temperature of the fuel cell 14 is increased to increase the power generation efficiency of the fuel cell 14.

In the path 104, the coolant delivered by the pump 56 circulates in the circulation system 62 (that is, the air-conditioning channel 50) in a path passing through the heater 52 and the heater core 54. The heater 52 heats the coolant flowing through the air-conditioning channel 50. The heater core 54 performs heat exchange between the coolant in the air-conditioning channel 50 and the outside air, and heats the air. As a result, the air heated by the heater core 54 is supplied to the vehicle interior, thereby adjusting the vehicle interior temperature.

In this way, in S16 where FC outlet temperature is low, the coolant is circulated independently in the circulation system 61 (i.e., the path 102) and the circulation system 62 (i.e., the path 104). Therefore, the low-temperature coolant in the circulation system 61 does not flow into the circulation system 62, and it is possible to appropriately perform heating in the heater core 54 by using the heat of the coolant heated by the heater 52.

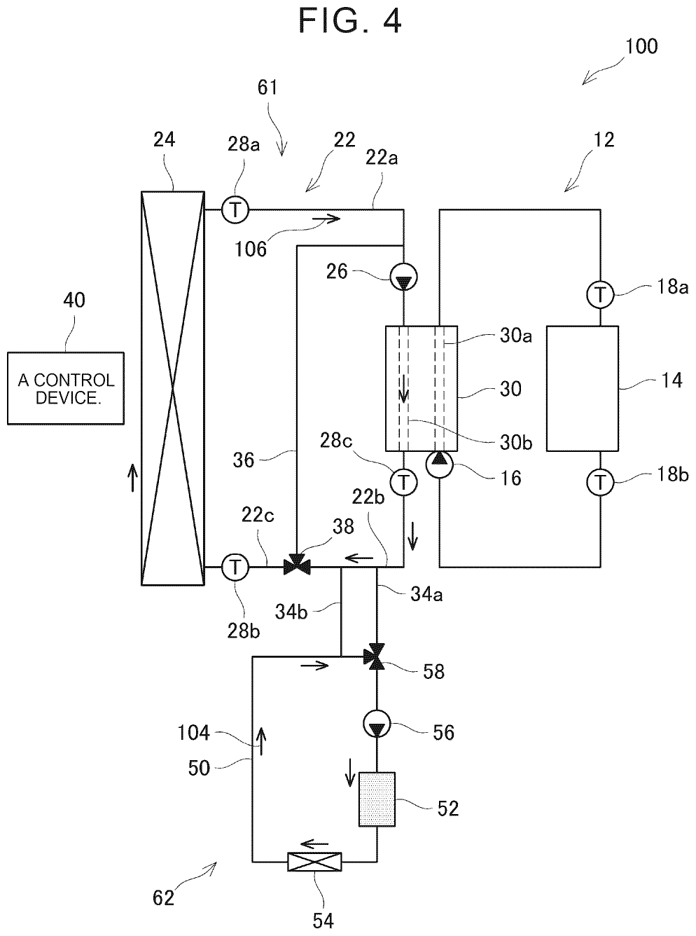

When FC outlet is hot (i.e., when the bypass channel 36 is closed), the coolant in the second cooling channel 22 circulates in the paths 106 and 104 indicated by the arrows in FIG. 4 in S16. The path 104 shown in FIG. 4 is the same as the path 104 shown in FIG. 3. In the path 106, the coolant delivered by the pump 26 circulates in the circulation system 61 in a path passing through the intermediate heat exchanger 30, the channel 22b, the channel 22c, the radiator 24, and the channel 22a. Since the coolant in the circulation system 61 is cooled by the radiator 24, the temperature of the coolant flowing into the intermediate heat exchanger 30 is low. Therefore, in the intermediate heat exchanger 30, the coolant in the first cooling channel 12 is efficiently cooled. Therefore, the fuel cell 14 is efficiently cooled by the coolant in the first cooling channel 12. Thus, when FC outlet is hot, the radiator 24 is activated to efficiently cool the fuel cell 14.

In this way, in S16 where FC outlet temperature is higher, the coolant is circulated independently in the circulation system 61 (i.e., the path 106) and the circulation system 62 (i.e., the path 104). Therefore, the low-temperature coolant in the circulation system 61 does not flow into the circulation system 62, and it is possible to appropriately perform heating in the heater core 54 by using the heat of the coolant heated by the heater 52.

The control device 40 repeatedly executes S16, S26 from S2 to S8, S12 while the outlet temperature of the intermediate heat exchanger 30 is equal to or lower than the determination temperature T3. Therefore, while the outlet temperature of the intermediate heat exchanger 30 is equal to or lower than the determination temperature T3, the control device 40 executes the above-described S16 operation until the power supply of the vehicle is turned OFF (that is, YES at S26).

If the outlet temperature of the intermediate heat exchanger 30 exceeds the determination temperature T3 (NO in S14), the control device 40 controls the three-way valve 58 with the first connecting channel 34a open (S18). Here, the coolant flows through the first connecting channel 34a and the second connecting channel 34b. That is, the coolant circulates between the circulation system 61 and the circulation system 62.

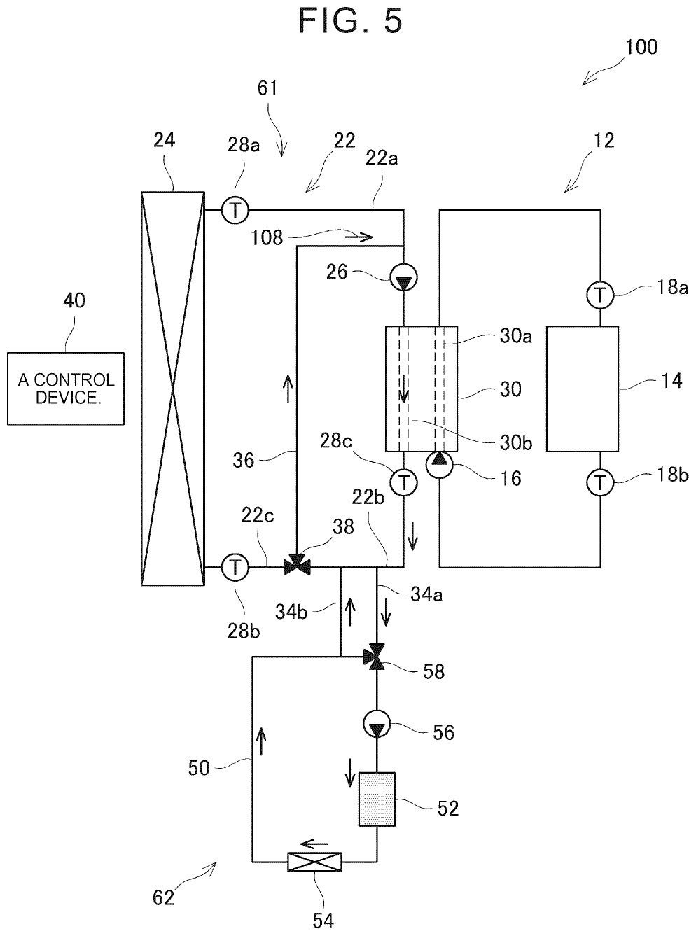

When FC outlet temperature is low (i.e., when the bypass channel 36 is open), in S18, the coolant in the second cooling channel 22 circulates in the path 108 indicated by the arrow in FIG. 5. In the path 108, the coolant delivered by the pump 26 circulates in the second cooling channel 22 in a path passing through the intermediate heat exchanger 30, the channel 22b, the first connecting channel 34a, the heater 52, the heater core 54, the second connecting channel 34b, and the bypass channel 36. Since the coolant in the second cooling channel 22 is not cooled by the radiator 24, the temperature of the coolant flowing into the intermediate heat exchanger 30 is not very low. Therefore, in the intermediate heat exchanger 30, the cooling efficiency when cooling the coolant in the first cooling channel 12 is low. Therefore, the cooling efficiency of the fuel cell 14 is low, and the temperature of the fuel cell 14 gradually increases. As the temperature of the fuel cell 14 increases, the power generation efficiency of the fuel cell 14 increases.

In the intermediate heat exchanger 30, the coolant in the second cooling channel 22 is heated by heat exchange between the first cooling channel 12 and the second cooling channel 22. As described above, S18 is performed when the outlet temperature of the intermediate heat exchanger 30 exceeds the determination temperature T3. Therefore, in S18, the high-temperature coolant that has passed through the intermediate heat exchanger 30 flows into the air-conditioning channel 50. The heater 52 further heats the coolant in the air-conditioning channel 50, and the heater core 54 performs heating by using the heat of the coolant in the air-conditioning channel 50. Since the temperature of the coolant supplied from the intermediate heat exchanger 30 to the air-conditioning channel 50 is high, it is not necessary to raise the temperature of the coolant by the heater 52 so much. Therefore, the heater 52 can be operated at a low output, and the power consumption of the heater 52 is reduced. As described above, when the outlet temperature of the intermediate heat exchanger 30 is high, the heat generated in the fuel cell 14 is supplied to the heater core 54 via the first cooling channel 12, the intermediate heat exchanger 30, and the second cooling channel 22, so that the power consumption of the heater 52 can be reduced.

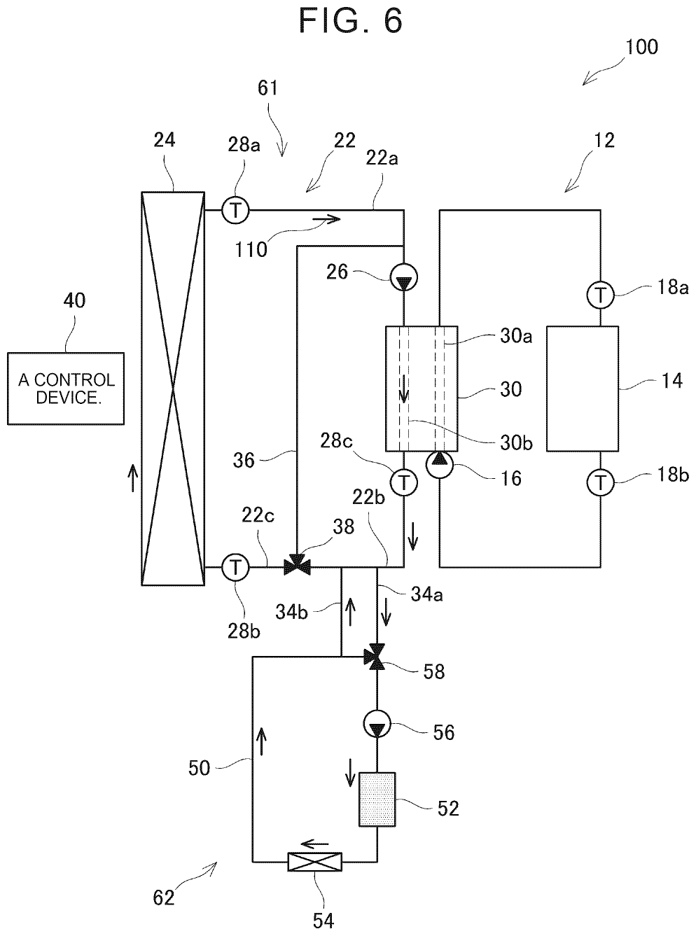

When FC outlet is hot (i.e., when the bypass channel 36 is closed), the coolant in the second cooling channel 22 circulates in the path 110 indicated by the arrow in FIG. 6 in S18. In the path 110, the coolant delivered by the pump 26 circulates in the second cooling channel 22 in a path passing through the intermediate heat exchanger 30, the channel 22b, the first connecting channel 34a, the heater 52, the heater core 54, the second connecting channel 34b, the channel 22c, the radiator 24, and the channel 22a. Since the coolant in the second cooling channel 22 is cooled by the radiator 24, the temperature of the coolant flowing into the intermediate heat exchanger 30 is low. Therefore, in the intermediate heat exchanger 30, the coolant in the first cooling channel 12 is efficiently cooled. Therefore, the fuel cell 14 is efficiently cooled by the coolant in the first cooling channel 12.

In the intermediate heat exchanger 30, the coolant in the second cooling channel 22 is heated by heat exchange between the first cooling channel 12 and the second cooling channel 22. As described above, S18 is performed when the outlet temperature of the intermediate heat exchanger 30 exceeds the determination temperature T3. Therefore, in S18, the high-temperature coolant that has passed through the intermediate heat exchanger 30 flows into the air-conditioning channel 50. The heater 52 further heats the coolant in the air-conditioning channel 50, and the heater core 54 performs heating by using the heat of the coolant in the air-conditioning channel 50. Since the temperature of the coolant supplied from the intermediate heat exchanger 30 to the air-conditioning channel 50 is high, it is not necessary to raise the temperature of the coolant by the heater 52 so much. Therefore, the heater 52 can be operated at a low output, and the power consumption of the heater 52 is reduced. As described above, when the outlet temperature of the intermediate heat exchanger 30 is high, the heat generated in the fuel cell 14 is supplied to the heater core 54 via the first cooling channel 12, the intermediate heat exchanger 30, and the second cooling channel 22, so that the power consumption of the heater 52 can be reduced.

The control device 40 repeatedly executes S8, S12, S14, S18, S26 from S2 while the outlet temperature of the intermediate heat exchanger 30 exceeds the determination temperature T3. Thus, while the outlet temperature of the intermediate heat exchanger 30 is above the determination temperature T3, the control device 40 performs S18 operations described above until the power of the vehicle is turned OFF (i.e., YES at S26).

When the outside air temperature exceeds the cold determination temperature T2 (when S12 is NO), the control device 40 determines whether or not the outlet temperature of the intermediate heat exchanger 30 is equal to or lower than the determination temperature T4 (S20). The determination temperature T4 differs from the determination temperature T3 of S14.

When the outlet temperature of the intermediate heat exchanger 30 is equal to or lower than the determination temperature T4 (YES in S20), the control device 40 executes S22. In S22, the same operation as that of S16 is executed.

When the outlet temperature of the intermediate heat exchanger 30 exceeds the determination temperature T4 (NO in S20), the control device 40 executes S24. In S24, the same operation as that of S18 is executed.

As described above, S24 from S20 is the same as that from S14 to S18 except that the determination times differ.

As described above, the control device 40 selectively executes the operations of FIGS. 3 to 6 when there is a heating request.

When the temperature of the coolant in the second cooling channel 22 is high, the coolant in the second cooling channel 22 is circulated in a path that straddles the circulation system 61 and the circulation system 62 by the operation of FIG. 5 or 6. As a result, the heat generated in the fuel cell 14 can be used in the heater core 54, and the power consumption of the heater 52 can be reduced. In this case, when the temperature of the fuel cell 14 is low, the temperature of the fuel cell 14 is increased by the operation of FIG. 5 (that is, the operation of not cooling the coolant by the radiator 24). When the temperature of the fuel cell 14 is high, the temperature of the fuel cell 14 is lowered by the operation of FIG. 6 (that is, the operation of cooling the coolant by the radiator 24). Therefore, it is possible to prevent the temperature of the fuel cell 14 from becoming excessively high while suppressing a decrease in power generation efficiency due to a decrease in the temperature of the fuel cell 14.

In addition, when the temperature of the coolant in the second cooling channel 22 is low, the coolant in the second cooling channel 22 is circulated through the respective independent paths of the circulation system 61 and the circulation system 62 by the operation of FIG. 3 or 4. Accordingly, it is possible to prevent the low-temperature coolant from flowing into the air-conditioning channel 50, and to prevent an increase in power consumption of the heater 52. In this case, when the temperature of the fuel cell 14 is low, the temperature of the fuel cell 14 is increased by the operation of FIG. 3 (that is, the operation of not cooling the coolant by the radiator 24). When the temperature of the fuel cell 14 is high, the temperature of the fuel cell 14 is lowered by the operation of FIG. 4 (that is, the operation of cooling the coolant by the radiator 24). Therefore, it is possible to prevent the temperature of the fuel cell 14 from becoming excessively high while suppressing a decrease in power generation efficiency due to a decrease in the temperature of the fuel cell 14.

The operation of executing S18 while the bypass channel 36 of the embodiment is open is an example of the first operation. The operation of executing S16 while the bypass channel 36 of the embodiment is open is an example of the second operation. The operation of the embodiment is an example of the third operation in which S18 is executed while the bypass channel 36 is closed. The operation of executing S16 while the bypass channel 36 of the embodiment is closed is an example of the fourth operation.

In the embodiment, the flow path changing device for changing the flowing path of the coolant in the second cooling channel 22 is configured by the three-way valves 38 and 58, but the flow path changing device may be configured by other devices. Further, in the embodiment, the three-way valves 38 and 58 are solenoid valves, but the channel changing device may be configured by a device that does not use electricity. For example, a channel changing device may be configured by a device that switches a channel by thermal expansion of a material, such as a thermostat.

In the embodiment, the first to fourth operations were performed by comparing the outlet temperature of the intermediate heat exchanger 30 with the determination temperature T3, T4. However, the first to fourth operations may be performed by comparing FC outlet temperature with the determination temperature T3, T4.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A fuel cell cooling system, comprising:
a first cooling channel in which coolant circulates;
a fuel cell provided on the first cooling channel;
a second cooling channel in which coolant circulates;
a radiator provided on the second cooling channel;
a heater that heats coolant in the second cooling channel;
a heater core that heats air by heat exchange with coolant in the second cooling channel; and
an intermediate heat exchanger that performs heat exchange between the first cooling channel and the second cooling channel, wherein:
the second cooling channel includes a bypass channel provided in parallel to the radiator; and
during power generation by the fuel cell, a first operation is executable in which coolant is circulated in the first cooling channel over a path through the fuel cell and the intermediate heat exchanger, and also coolant is circulated in the second cooling channel over a path through the intermediate heat exchanger, the heater, the heater core, and the bypass channel, and the air is heated by the heater core.

2. The fuel cell cooling system according to claim 1, wherein:
the second cooling channel includes
a first circulation system including the bypass channel,
a second circulation system,
a first connecting channel connecting the first circulation system and the second circulation system, and
a second connecting channel connecting the first circulation system and the second circulation system;
the intermediate heat exchanger and the radiator are provided in the first circulation system;
the heater and the heater core are provided in the second circulation system;
the first operation and a second operation are executable;
in the first operation, the coolant is circulated in the second cooling channel over a path passing through the intermediate heat exchanger, the first connecting channel, the heater, the heater core, the second connecting channel, and the bypass channel; and
in the second operation, during power generation by the fuel cell, coolant is circulated in the first cooling channel over a path passing through the fuel cell and the intermediate heat exchanger, coolant is circulated in the first circulation system over a path passing through the intermediate heat exchanger and the bypass channel, and coolant is circulated in the second circulation system over a path passing through the heater and the heater core to heat the air by the heater core.

3. The fuel cell cooling system according to claim 1, wherein, during power generation by the fuel cell, a third operation is executable in which coolant is circulated in the first cooling channel over a path passing through the fuel cell and the intermediate heat exchanger, and also coolant is circulated in the second cooling channel over a path passing through the intermediate heat exchanger, the heater, the heater core, and the radiator to heat air by the heater core.

4. The fuel cell cooling system according to claim 2, wherein, during power generation of the fuel cell, a fourth operation is executable in which coolant is circulated in the first cooling channel over a path passing through the fuel cell and the intermediate heat exchanger, the coolant is circulated in the first circulation system over a path passing through the intermediate heat exchanger and the radiator, and coolant is circulated in the second circulation system over a path passing through the heater and the heater core to heat air by the heater core.
